(19) United States
(12) Patent Application Publication
(10) Pub. No.: US 2002/0069239 A1
(43) Pub. Date: Jun. 6, 2002

(54) Data transmission system and its method

(75) Inventors: Toshiharu Katada, Nagano-ken (JP); Yutaka Hisamatsu, Nagano-ken (JP); Fumio Nagasaka, Nagano-ken (JP)

Correspondence Address: OLIFF & BERRIDGE, PLC, P.O. BOX 19928, ALEXANDRIA, VA, 22320, US

(73) Assignee: SEIKO EPSON CORPORATION, Tokyo, JP

(21) Appl. No.: 09/989,543

(22) Filed: Nov. 21, 2001

(30) Foreign Application Priority Data
Dec. 6, 2000 (JP) 2000-371066

(51) Int. Cl. G06F 15/16

(52) U.S. Cl. 709/202; 709/218

(57) ABSTRACT

An image displayed in a scanner home page is dragged and dropped in a printer home page (S100). The URL of a device service unit of the scanner side is transmitted from a web browser unit of the scanner side to a web browser unit of the printer side (S102). The URL is transmitted from the web browser unit of the printer side to the device service unit of the printer side via a web server unit in the printer side (S104). The device service unit of the printer side, based on the URL, accesses the device service unit of the scanner side and acquires the image data (S106). The image data is transmitted from the device service unit of the printer side to the printer (S108).

Therefore, it is possible to command data transmissions by means of a simple operation, without running the different application programs for each device.

### BACKGROUND OF THE INVENTION

1. Field of the Invention

The present invention concerns a technology for the transmission of specific data obtained from a device to another device.

2. Description of Related Art

Conventionally, for instance, in a printer an a scanner connected to a computer, when the image data fetched by the scanner has to be printed by the printer, first the application supporting the scanner has to be run; by means of the application program that controls the scanner, the image data is read by the scanner and then stored in the computer's memory. Next, the application program that supports the printer is run, reading the image data stored in its memory and controlling the printer in order to print the image data.

Thus, for the transmission of data between printers, scanners etc it is necessary to run the multiple unrelated application programs that support each device.

Also, when transmitting data between devices, the individual different user interfaces of these devices have to be specified, which detracts from the operability for the user.

### SUMMARY OF THE INVENTION

Therefore, the object of the present invention is to provide a data transmission system for commanding data transmissions by means of a simple operation without running different application programs for each device.

At least part of the above and the other related objects is attained by the first data transmission system for transmission of specific data obtained in a first device to a second device via a network. The first data transmission system includes: an input element for inputting instructions; and a location information transmission element that transmits at least one of a location information of the first device and a location information of the specific data to the second device via the network based on the instructions, wherein the second device accesses the first device based on the location information and receives the transmission of the specific data from the first device.

The present invention is also directed to a first data transmission method for transmission of specific data obtained in a first device to a second device via a network. The first data transmission method includes the steps of: (a) transmitting at least one of a location information of the first device and a location information of the specific data to the second device via the network based on an inputted instruction; and (b) causing the second device to access the first device based on the location information and receive the transmission of the specific data from the first device.

In the detailed description of the present invention, the location information includes for example URL (Uniform resource locator), IP (Internet Protocol) addresses, GUID (Global Unique ID). The specific data may include image data, sound data, text data or any other kind of data.

In the first transmission system and its method, the user has only to command the selection of the first and the second device, and the location information of the first device or of the specific data is sent to the second device via the network; and based on that, the specific data is transmitted to the second device from the first device via the network. Therefore, it is possible to command data transmissions by means of a simple operation, without running the different application programs for each device.

The present invention is also directed to a second data transmission system for transmission of specific data obtained in a first device to a second device via a network. The second data transmission system includes: an input element for inputting instructions; and a location information transmission element transmits a location information of the second device to the first device based on the instructions, wherein the first device accesses the second device based on the location information and transmits the specific data to the second device.

The present invention is further directed to a second data transmission method for transmission of specific data obtained in a first device to a second device via a network. The second data transmission method includes the steps of: (a) transmitting the location information of the second device to the first device via the network based on an inputted instruction; and (b) causing the first device to access the second device based on the location information and transmit the specific data to the second device.

Therefore, in the second transmission system and its method, the user has only to command the selection of the first and the second device, and the location information of the second device data is sent to the first device via the network, and based on that, the specific data is transmitted to the second device from the first device via the network. Thus, in this case as well, it is possible to command data transmissions by means of a simple operation, without running the different application programs for each device.

In a preferred embodiment of the first or the second data transmission systems, the input element and the location information transmission element are included in a device directly connected to the network but other than the first or the second devices.

In such an embodiment, the user can perform the transmission of data from the first device to the second device in a remote operation.

In the first or the second data transmission systems above, the specific data can also be transmitted from the first device to the second device via a further device, other than the first or second devices, directly connected to the network.

This way, the specific data cannot only be transmitted directly from the first device to the second device directly, but also by way of another device.

In a preferred embodiment of the first or the second data transmission systems, a search element is provided which, as instructed to, can search from among the devices directly connected to the network, the device groups belonging to the first or the second device.

By providing such a search element, the user, just by commanding the search from the input element, con search the device groups belonging to the first or the second device, so it is easy to obtain the location information of all the devices included in the device groups.

The present invention is also directed to a third data transmission system for transmission of specific data obtained in a first device to a second device. The third data transmission system includes: a first device service unit that generates data in order to display a web page used for the first device, and which can exchange the specific data with the first device; a second device service unit that generates data in order to display a web page used for the second device, and which can exchange the specific data with the second device; a first web server unit that sends the data generated by the first device service unit according to a request; a second web server unit that sends the data generated by the second device service unit according to a request; a first web browser unit that sends the request to the first server unit, receives the data sent by the first server unit, and which, based on the data, displays the web page used for the first device including data symbols for displaying the specific data on a screen; a second web browser unit that sends the request to the second server unit, receives the data sent by the second server unit, and which, based on the data, displays the web page used for the second device on same the screen, wherein, when the data symbols on the screen included in the web page used for the first device are drag-and-dropped in a predetermined area of the web page used for the second device, the first web browser unit hands over at least one of a location information of the first device service unit and a location information of the specific data to the second web browser unit, the second web browser unit forwards the handed over location information to the second device service via the second web server unit, and the second device service unit accesses the first device service unit based on the forwarded location information, acquires from the first device service unit the specific data obtained from the first device, and sends the specific data over to the second device.

The present invention is further directed to a third data transmission method for transmission of specific data obtained in a first device to a second device. The third data transmission method includes the steps of: (a) providing a first device service unit that generates data in order to display a web page used for the first device, and which can exchange the specific data with the first device, a second device service unit that generates data in order to display a web page used for the second device, and which can exchange the specific data with the second device, a first web server unit that sends the data generated by the first device service unit according to a request, a second web server unit that sends the data generated by the second device service unit according to a request, a first web browser unit that sends the request to the first server unit, receives the data sent by the first server unit, and which, based on the data, displays the web page used for the first device including data symbols for displaying the specific data on a screen, and a second web browser unit that sends the request to the second server unit, receives the data sent by the second server unit, and which, based on the data, displays the web page used for the second device on same the screen; (b) drag-and-dropping the data symbols on the screen included in the web page used for the first device in a predetermined area of the web page used for the second device; (c) causing the first web browser unit to hand over at least one of a location information of the first device service unit and a location information of the specific data to the second web browser unit; (d) causing the second web browser unit to forward the handed over location information to the second device service unit via the second web server unit; (e) causing the second device service unit to access the first device service based on the forwarded location information and acquire from the first device service unit the specific data obtained from the first device; and (f) causing to the second device service unit to hand over the acquired specific data to the second device.

In this context web means WWW (world wide web)

Thus, in the third data transmission system of the present invention, the data symbols contained in the web page used for the first device in the third data transmission system or its method, when dragged and dropped in the predetermined area of the web page used for the second device, the location information of the first device service unit or of the specific data is handed over from the first web browser unit to the second web browser unit, and also to the second device service unit via the second web server unit. This way, the second device service unit, using this location information, accesses the first device service unit, acquires the specific data from the first device, and delivers it to the second device.

Therefore, by means of the third data transmission system and its method, just by drag-and-dropping the desired data symbols between the web pages appearing on the screen, it is possible to carry out the transmission of specific data between devices. Thus, it is possible to command data transmission by means of a simple operation, without running the different application programs for each device. Also, thanks to the use of HTTP between the web browser unit and the web server unit, it is possible to exchange data and information without making any distinction between local and network connections.

In a preferred embodiment of the third data transmission system of the present invention, a third web server unit is preferably provided between the first device service unit and the second device service unit, the second device service unit accesses the first device service unit via the third web server unit based on the delivered location information, and acquires the specific data from the first device service unit using HTTP (Hypertext Transfer Protocol) via the third web server unit.

In a preferred embodiment of the third data transmission system of the present invention, a FTP server unit is provided between the first device service unit and the second device service unit, the second device service unit accesses the first device service unit via the FTP server unit based on the delivered location information, and acquires the specific data from the first device service unit using FTP (File Transfer Protocol) via the FTP web server unit.

In a preferred embodiment of the third data transmission system of the present invention, the second device service unit acquires the specific data from the first device service unit using IPP (Internet Printing Protocol).

Thus, by using HTTP (Hypertext Transfer Protocol), FTP (File Transfer Protocol) or IPP (Internet Printing Protocol), it is possible to carry out the transmission of specific data between the first and the second device service units without making any distinction between local and network connections.

The present invention is also directed to a fourth data transmission system for transmission of specific data obtained in a first device to a second device. The fourth data transmission system includes: a first device service unit that generates data in order to display a web page used for the first device, and which can exchange the specific data with the first device, a second device service unit that generates data in order to display a web page used for the second device, and which can exchange the specific data with the second device, a first web server unit that sends the data generated by the first device service unit according to a request, a second web server unit that sends the data generated by the second device service unit according to a request, a first web browser unit that sends the request to the first server unit, receives the data sent by the first server unit, and which, based on the data, displays the web page used for the first device including data symbols for displaying the specific data on a screen, a second web browser unit that sends the request to the second server unit, receives the data sent by the second server unit, and which, based on the data, displays the web page used for the second device on same the screen; wherein, when the data symbols on the screen included in the web page used for the first device are drag-and-dropped in a predetermined area of the web page used for the second device, the second web browser unit hands over a location information of the second device service unit to the first web browser unit, the first web browser unit forwards the handed over location information to the first device service unit via the first web server unit, the first device service unit accesses the second device service unit based on the forwarded location information and sends the specific data obtained from the first device over to the second device service unit, and the second device service unit receives the specific data and delivers the specific data to the second device.

The present invention is further directed to a fourth data transmission method for transmission of specific data obtained in a first device to a second device. The fourth data transmission method includes the steps of: (a) providing a first device service unit that generates data in order to display a web page used for the first device, and which can exchange the specific data with the first device, a second device service unit that generates data in order to display a web page used for the second device, and which can exchange the specific data with the second device, a first web server unit that sends the data generated by the first device service unit according to a request, a second web server unit that sends the data generated by the second device service unit according to a request, a first web browser unit that sends the request to the first server unit, receives the data sent by the first server unit, and which, based on the data, displays the web page used for the first device including data symbols for displaying the specific data on a screen, and a second web browser unit that sends the request to the second server unit, receives the data sent by the second server unit, and which, based on the data, displays the web page used for the second device on same the screen; (b) drag-and-dropping the data symbols on the screen included in the web page used for the first device in a predetermined area of the web page used for the second device; (c) causing the second web browser unit to hand over a location information of the second device service unit to the first web browser unit; (d) causing the first web browser unit to forward the handed over location information to the first device service unit via the first web server unit; (e) causing the first device service unit to access the second device service unit based on the forwarded location information and send the specific data obtained from the first device over to the second device service unit; (i) causing the second device service unit to receive the specific data; and (g) causing the second device service unit to deliver the received specific data to the second device.

Thus, when the data symbols contained in the web page used for the first device in the fourth data transmission system or its method are dragged and dropped in a predetermined area in the web page used for the second device, the location information of the first device service unit is handed over from the second web browser unit to the first web browser unit, and also to the first device service unit via the first web server unit. This way, the first device service unit, using this location information, accesses the second device service unit and sends the specific data from the first device. The second device service unit receives the specific data and delivers it to the second device.

Therefore, in the fourth data transmission system and its method as well, just by drag-and-dropping the desired data symbols between the web pages appearing on the screen, it is possible to carry out the transmission of specific data between devices. Thus, it is possible to command data transmission by means of a simple operation, without running the different application programs for each device. Also, thanks to the use of HTTP between the web browser unit and the web server unit, it is possible to exchange data and information without making any distinction between local and network connections.

In a preferred embodiment of the fourth data transmission system, the first device service unit sends the specific data to the second device service unit using IPP (Internet Printing Protocol).

In a preferred embodiment of the fourth data transmission system, the first device service unit sends the specific data to the second device service unit using LPR.

Thus, by using IPP or LPR, it is possible to carry out the transmission of specific data between the first and the second device service units without making any distinction between local and network connections.

These and other objects, features, aspects, and advantages of the present invention will become more apparent from the following detailed description of the preferred embodiment with the accompanying drawings.

### BRIEF DESCRIPTION OF THE DRAWINGS

FIG. 1 is a block diagram showing the structure of the first embodiment of a data transmission system of the present invention.

FIG. 2A through 2C are block diagrams showing representative examples of suitable connection embodiments for the data transmission system of FIG. 1.

FIG. 3A through 3C are block diagrams showing representative examples of suitable connection embodiments for the data transmission system of FIG. 1.

FIG. 4 is a block diagram showing schematically the hardware structure of the computers depicted in FIG. 2A.

FIG. 5 is a explanatory drawing depicting the web page of printer 230p and the web page of scanner 130s as they appear on the screen of a monitor 309 of FIG. 1.

FIG. 6 is a flowchart explaining the process operation for the data transmission system of FIG. 1.

FIG. 7 is a flowchart explaining the process operation for the data transmission system corresponding to the second embodiment of the present invention.

FIG. 8 is a block diagram showing schematically the hardware structure of the data transmission system corresponding to the third embodiment of the present invention.

FIG. 9 is a flowchart explaining the process operation for the data transmission system of FIG. 8.

FIG. 10 is a drawing explaining the command procedure for the cellular phone 700 of FIG. 8.

FIG. 11 is a flowchart explaining the process operation for the data transmission system corresponding to the fourth embodiment of the present invention.

FIG. 12 is a flowchart explaining the process operation for the data transmission system corresponding to the fifth embodiment of the present invention.

FIG. 13 is a block diagram depicting a variation of the data transmission system of the present invention

### DESCRIPTION OF THE PREFERRED EMBODIMENTS

The embodiments of the present invention are explained by means practical examples in the following order:

A. First Embodiment

A-1. Structure of the first embodiment

A-2. Operation of the first embodiment

B. Second Embodiment

B-1. Structure of the second embodiment

B-2. Operation of the second embodiment

C. First Embodiment

C-1. Structure of the third embodiment

C-2. Operation of the third embodiment

D. Fourth Embodiment

D-1. Operation of the fourth embodiment

E. Fifth Embodiment

E-1. Operation of the fifth embodiment

### A. First Embodiment

### A-1. Structure of the First Embodiment

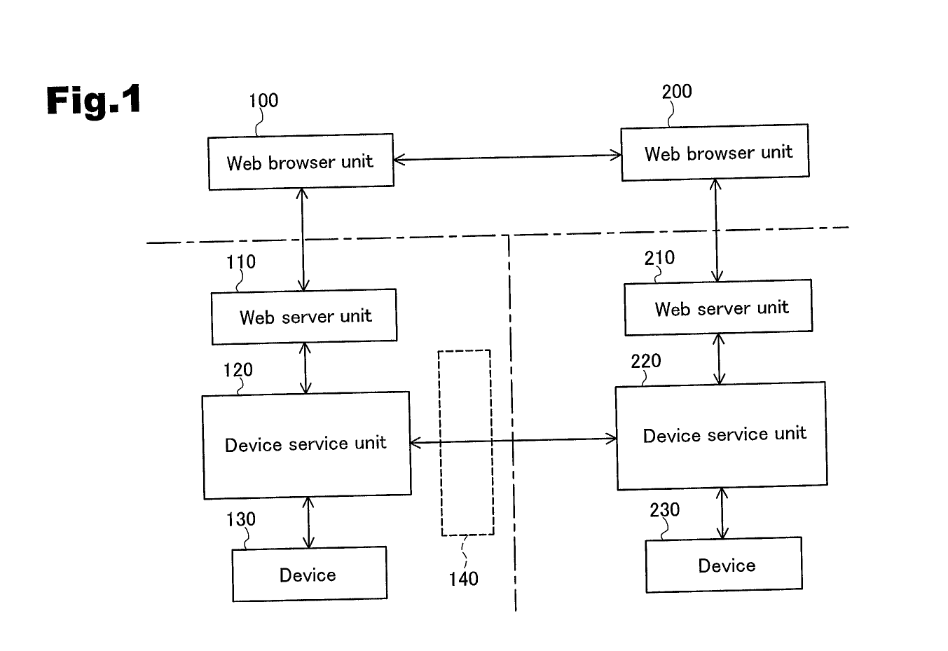

FIG. 1 is a block diagram showing the structure of the first embodiment of a data transmission system of the present invention. In FIG. 1, devices 130 and 230, for example, a printer, a scanner etc. are devices to be controlled.

In the example of FIG. 1, the data transmission system of the present invention provides mainly: web browser units 100 and 200 for displaying web pages on screen; web server units 110 and 210 for sending the data, as requested by the web browser units 100 and 200, for displaying web pages on screen; and device service units 120 and 220 that can control devices 130 and 230 respectively.

The web browser units 100 and 200 are generated by web browser software, the web server units 110 and 210 are generated by web server software. The device service unit 120 for the device 130, is generated by a device control program including the device drivers of the device 130. Similarly, the device service unit 220 for the device 230, is generated by a device control program including the device drivers used by the device 230.

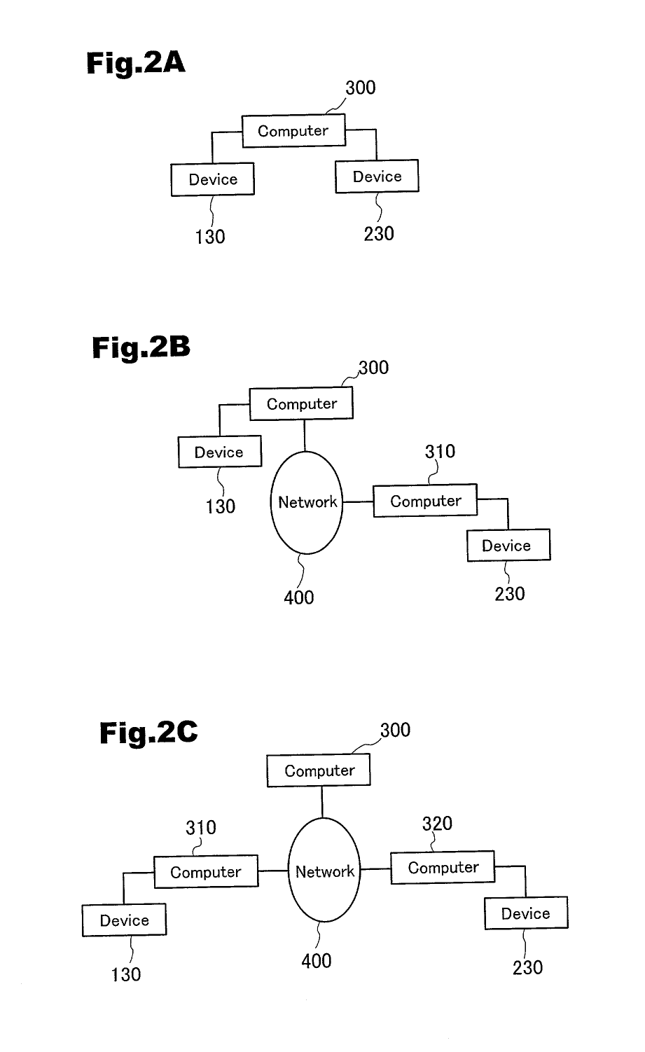

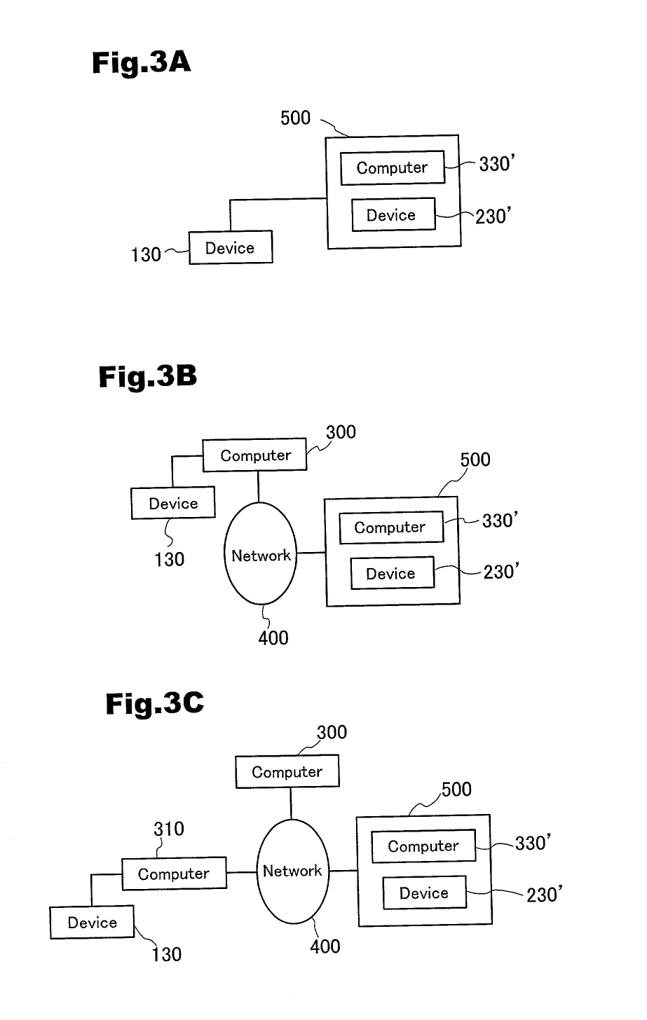

FIG. 2 and FIG. 3 are block diagrams showing representative examples of suitable connection embodiments for the data transmission system of FIG. 1.

In FIG. 2A, the two devices 130 and 230 of FIG. 1 are directly connected to a computer 300. In this case, therefore, the constitutive elements other than the devices 130 and 230, i.e. the web browser units 100 and 200, the web server units 110 and 210, and the device service units 120 and 220 co-exist all in the same computer 300.

In the example of FIG. 2B, the two the devices 130 and 230 are connected each to two computers 300 and 310, which in their turn are connected via network 400. In this case, among the constitutive elements other than the devices 130 and 230, the web browser units 100 and 200, the web server unit 110 and the device service unit 120 are in the computer 300; the web server unit 210 and the device service unit 210 are in the computer 310. Therefore, the web browser units 100 and 200, the web server unit 110 and the device service unit 120 are in the same computer 300, but because the web server unit 210 and the device service unit 220 are in a different computer 320, there is in FIG. 1 a dashed line marking the boundary between the web browser unit 200 and the web server unit 210, and between the device service unit 120 and the device service unit 200, this boundary represents the network boundary.

The network 400 can be any adequate network such as Internet, Intranet, Local Area Network (LAN), Wide Area Network (WAN), etc.

In the example of FIG. 2C, three computers 300, 310 and 320 are connected via the network 400, the two the devices 130 and 230 are connected each to the computers 310 and 320 respectively. In this case, among the main constitutive elements other than the devices 130 and 230, the web browser units 100 and 200 are in the computer 300, the web server unit 110 and the device service unit 120 are in the second the computer 310, the web server unit 210 and the device service unit 220 are in the third the computer 320. Therefore, the web server unit 110 and the device service unit 120, and the web server unit 210 and the device service unit 220 are in different computers, they are all also in a computer different to the computer in which the web browser units 100 and 200 are, for this reason there is in FIG. 1 a dashed line marking the boundary between all networks.

Also, the computer in FIG. 2 includes, apart from all kinds of computers like personal computers, portable computers, data processing terminals, workstations, etc., copiers, printers and other peripherals possessing in practice the same functions of a computer, and set top boxes (for example, an embodiment of an information terminal may be a Web TV reception terminal) etc. possessing those same computer functions, game machines, etc.

The devices in FIG. 2, though depicted as being connected to the computer from the outside, it makes no difference whether, depending on the embodiment of the device, both device and computer form a unity instead, as in FIG. 3.

The examples in FIG. 3A through 3C describe all a machine 500 incorporating a device 230′ and a computer 330′, where computer and device form a unity.

Also, every device need not necessarily have a web server unit as in FIG. 1. For instance, in cases the data transmission system shown in FIG. 1 is in a suitable connection embodiment as in FIG. 2A or FIG. 3A, the web server units 110 and 210 are in the same computer 300 and in the same computer 330′, respectively. In these cases there is no need for the devices 130 and 230 to incorporate each a web server unit, the connection to just one web server unit is sufficient.

We shall explain below different examples of the data transmission system of FIG. 1 in suitable connection embodiments such as the one shown in FIG. 2C.

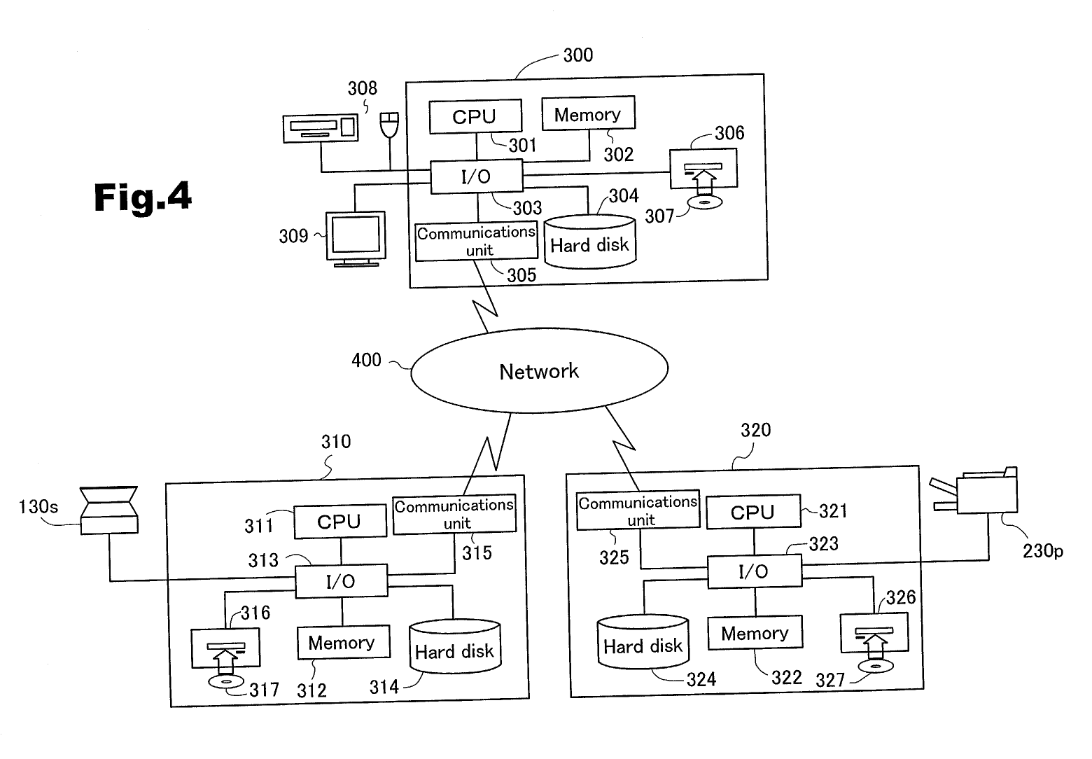

FIG. 4 is a block diagram showing schematically the hardware structure of the computers depicted in FIG. 2C. In the example depicted in FIG. 4, the device 130 and the device 230 will be scanner 130s and printer 230p respectively.

As shown in FIG. 4, the hardware structure in the computers 300, 310 and 320 incorporate mainly: CPUs 301, 311 and 321 for performing the various control and processing tasks in accordance with the computer programs, memory units 302, 312 and 322 for memorising the computer programs and to temporarily memorise data being processed, I/O elements 303, 313 and 323 for exchanging data etc. among the different peripheral devices, hard disk units 304, 314 and 324 to store the various data; communication elements 305, 315 and 325, including modems, terminal adapters, network cards etc., for communicating with other devices via the network; and CD-ROM drives 306, 316 and 326. Besides, the computer 300 is provided as well with an input unit 308 with keyboard, mouse, etc. for the input of the user commands, etc., and a CRT, liquid crystal display etc. the monitor 309 to enable the display of the web pages.

The computer 310 is connected to an external scanner 130s, as the sending device, and the computer 320 is connected to an external the printer 230p, as the receiving device. Furthermore, input units and monitors have been omitted in the computers 310 and 320.

Thus, the web browser units 100 and 200, the web server units 110 and 210, and the device service units 120 and 220, generated by computer programs, act as constitutive elements of those computers, specifically by means of the CPUs 310, 311 and 321 that read and run the desired computer programs stored in memory units 302, 312, 322 in the computers 300, 310 and 320 respectively.

In the present embodiment, all programs stored in memory units 302, 312 and 322 are provided in recorded state on CD-ROMs 307, 317 and 327, respectively, as the record media, are fetched by the computers 300, 310 and 320, and are in the CD-ROM drive units 300, 310 and 320. The computer programs thus read, are transferred to the hard disk units 304, 314, 324, to be transferred afterwards to memory units 302, 312 and 322 when run. Alternatively, the computer programs can also be transferred directly to the memory units 302, 312 and 322, without intervening hard disk units.

Thus, for the purposes of the present embodiment, we have described the use of CD-ROM as “record media” to record computer-readable computer programs, but other kind of computer-readable media can be used as well, such as flexible disks, photomagnetic disks, IC cards, ROM cartridges, punch cards, bar codes and other materials printed with symbols, internal memory devices in computers (RAM and ROM memory, etc.) and other external memory devices.

The computer programs, apart from being provided recorded in recording media, can also be supplied accessing a program server (not shown in the drawings) through a network and reading the computer programs from the program server.

These computer programs can also be composed of operating system programs.

### A-2. Operation of the First Embodiment

The operation of the data transmission system of FIG. 1 is explained below. In order to facilitate its comprehension, the explanation will use the scanner 130s as the device 130 and the printer 230p as the device 230. Also, the device service unit 120 will hold already the image data read by the scanner 130s.

Firstly, we will briefly explain the operation to display the web page of the printer 230p and the web page of the scanner 130s on the screen of the monitor 309 of the computer 300, following the command of the user of the computer 300, a pre-requisite for the operation of the present embodiment.

The user of the computer 300 activates the web browser software by operating the input unit 308. Thereupon, the web browser unit 100 is generated and a content window appears on the screen of the monitor 309. When the web browser unit 200 is prompted, another content window appears on the screen of the monitor 309. Thus, two content windows appear on the screen of the monitor 309.

When the user, for example, enters by means of input unit 308 the URL of the device service unit 120 of the computer 310 in a predetermined area of the first content window, the web browser unit that displays that content window (in this case, the web browser unit 100), recognises which web server unit to access and which data to acquire from which directory by checking that URL. Thus, the web browser unit 100 accesses the web server unit 110 of the target the computer 310 via the network 400 using HTTP, and requests the data for displaying the web page. Based on this request, the device service unit 120 of the computer 310 creates the data for displaying the web page of the scanner 130s, and the web server unit 110 sends the created data back to the web browser unit 100 through the network 400. The web browser unit 100 analyses the received data and displays the web page of the scanner 130s in the content window appearing on the screen of the monitor 309.

Similarly, when the user enters the URL of the device service unit 220 of the computer 310 in a predetermined area of the second content window, the web browser unit that displays that content window (in this case, the web browser unit 200), based on that URL, accesses the web server unit 210 of the target the computer 320 via the network 400 using HTTP, and requests the data to displayed the web page. Based on this request, the device service unit 220 of the computer 320 creates the data for displaying the web page of the printer 230p, and the web server unit 210 sends the created data back to the web browser unit 200 through the network 400. The web browser unit 200 analyses the received data and displays the web page of the printer 230p in the content window appearing on the screen of the monitor 309.

These web pages are created in the known web page application languages, such as HTML (Hypertext Markup Language), XML (Extensible Markup Language), etc.

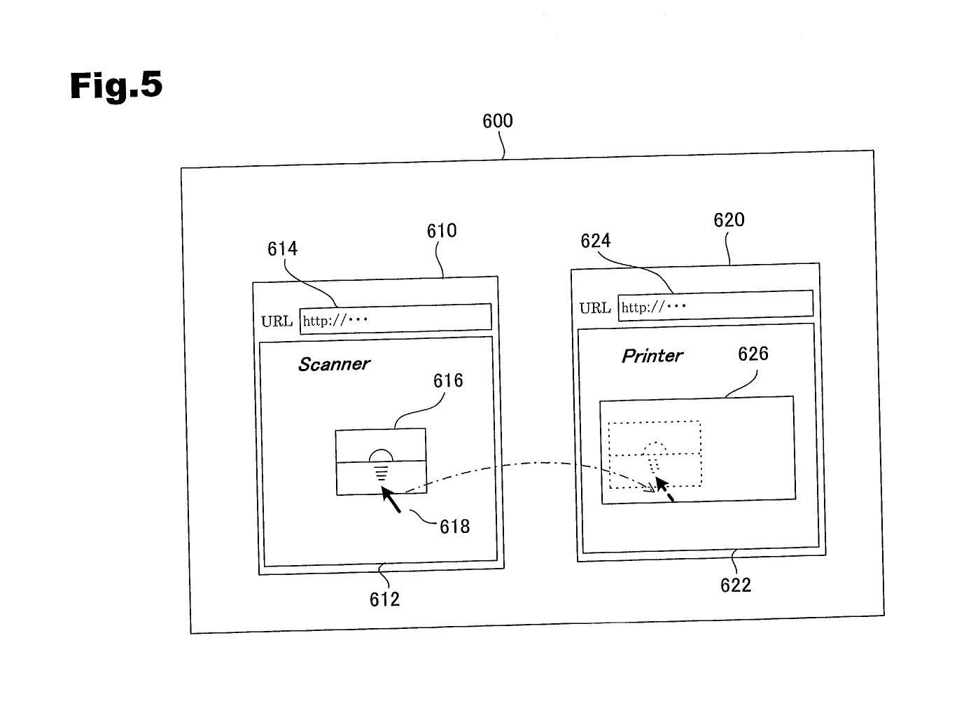

FIG. 5 is an explanatory drawing depicting the web page of the printer 230p and the web page of the scanner 130s as they appear on the screen of the monitor 309 of FIG. 1.

As FIG. 5 shows, the content window 610 from the web browser unit 100 and the content window 620 from the web browser unit 200 appear on the screen 600 of the monitor 309. As described above, when the user enters the URL of the device service unit 120 of the computer 310 in the URL input area 614 of the content window 610, the web page 612 of the scanner 130s appears inside the content window 610.

Then, the image 616 corresponding to the image data read by the scanner 130s and held by the device service unit 120 is displayed in web page 612 of the scanner 130s. The image 616 can go on being displayed unaltered, as per the image data, or be displayed as a so-called thumbnail image. Instead of the image 616, another icon or figure corresponding to the image data may be displayed.

Thus, when the user enters the URL of the device service unit 220 of the computer 320 in the URL input area 624 in content window 620, the web page 622 of the printer 230p is displayed on the content window 620. Then, in the web page 622 of the printer 230p, an command frame 622 is displayed to indicate the printing in the printer 230p.

We have explained above the pre-requisite operation for the present embodiment. Now we shall explain in detail the main operation of the present embodiment.

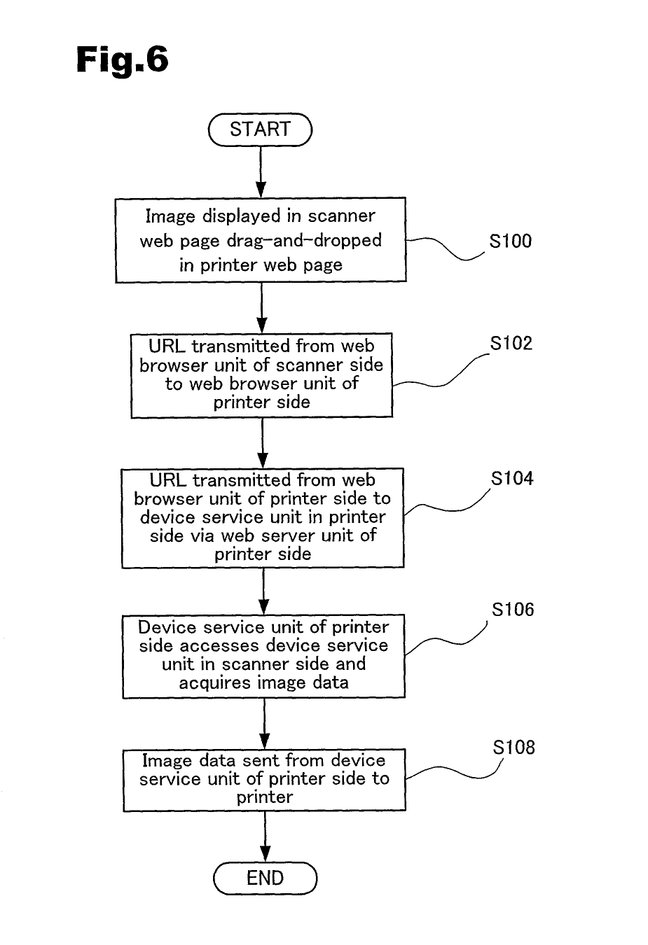

FIG. 6 is a flowchart explaining the process operation for the data transmission system of FIG. 1.

When the web page 612 of the scanner 130s and the web page 622 of the printer 230p are displayed on the screen of the monitor 309 in the computer 300 as shown in FIG. 5, the user, operating the input unit 308, drags the image 616 displayed in the web page 612 of the scanner 130s by means of the mouse-cursor 618 displayed on screen 600, as shown by the dotted arrow, and drops it inside the command frame 626 displayed in the web page 622 of the printer 230p (step S100). Then, the web browser units 100 and 200 detect that image 616 displayed in the web page 612 of the scanner 130s has been dragged and dropped inside the command frame 626 displayed in the web page 622 of the printer 230p, and the URL of the device service unit 120 that holds the image data for image 616 is handed over from the web browser unit 100 to the web browser unit 200 (step S102). The URL can be delivered directly form the web browser unit 100 to the web browser unit 200, or through the operating system of the computer 300.

Next, the web browser unit 200 sends the delivered URL to the web server unit 210 by means of HTTP; the web server unit 210 relays it unchanged to the device service unit 220 (step S104). Then, the device service unit 220 checks the URL and recognises which data to acquire and where to access. Thereupon, the device service unit 220 accesses the target the device service unit 120 via the network 400 using IPP, and acquires the image data held by the device service unit 120 (step S106). Next, the device service unit 220 delivers the acquired image data to the printer 230p (step S108), where the target image is printed.

That way, in the present embodiment, the user of the computer 300, just by dragging and dropping the image 616 displayed in the web page 612 of the scanner 130s into the printing command frame 626 displayed in the web page 622 of the printer 230p, can transmit via the network 400, the image data for image 616 from the connected the scanner 130s to the printer 230p. Therefore, by means of the present embodiment, it is possible to provide a command for the transmission of data, by means of a simple operation, without having to run the different application programs for the different devices such as scanners, printers, etc.

In the above explanation, the data transmission system depicted in FIG. 1 has been explained by means of an embodiment of a suitable connection arrangement as shown in FIG. 2C, but in the present embodiment, because the data transmission and information exchange between web browser units and web server units is done using HTTP, and because the image data transmission between device service unit homologues uses IPP, no matter what the suitable connection embodiments of a data transmission system like the one described in FIG. 1 (connection embodiments such as those shown in FIG. 2A, 2B and FIG. 3A˜3C), it makes no difference whether the data transmission and the information exchange are carried out through a local connection or through a network connection.

In the embodiment above, the image data transmission between device service unit homologues was performed by means of IPP, but the image data transmission can be done as well using other protocols. To illustrate this point, we shall explain next a modification of the described embodiment.

In a first variation, the protocol used is HTTP. More specifically, a new web server unit, represented by a dashed box 140, is added between the device service unit 120 and the device service unit 220 in FIG. 1. This new server shares the same computer 310 of the device service unit 120.

Then, when the device service unit 220 acquires the image data from the device service unit 120, the device service unit 220, based on the delivered URL, accesses the web server unit using HTTP, and downloads the image data held in the device service unit 120 through this web server unit.

In a second variation, the protocol used is FTP. More specifically, a new FTP server is provided, represented by the same dashed box 140 in FIG. 1 as in the HTTP case. This new FTP server unit shares the same computer 310 of the device service unit 120.

Then, when the device service unit 220 acquires the image data from the device service unit 120, the device service unit 220, based on the delivered URL, accesses the FTP server unit using FTP, and downloads the image data held in the device service unit 120 through this FTP server unit.

That way, when the device service unit in the data acquisition end acquires the URL from its counterpart device service unit, the data can be transmitted, using HTTP or FTP by means of a web server unit or of a FTP server unit provided in the computer of the homologue device service unit. Using this kind of protocols, by carrying out the data transmission between device service unit homologues, the image data can be transmitted making no distinction between local or network connection.

### B, Second Embodiment

### B-1. Structure of the Second Embodiment

The structure of the present embodiment is the same as the structure shown in FIG. 1, although in the present embodiment there is no web or FTP server unit represented by dashed box 140.

In the present embodiment, the data transmission system of FIG. 1 shall be explained by means of an example of a suitable connection embodiment depicted in FIG. 2C. The hardware structure of all the computers in FIG. 2C is described in FIG. 4.

### B-2. Operation of the Second Embodiment

Here we shall explain the basic operation of the present embodiment. The pre-requisites for the operation of the present embodiment are the same as those set out above for the first embodiment, with the web page 612 of the scanner 130s and the web page 622 of the printer 230p displayed on the screen of the monitor 309 of the computer 300, as shown in FIG. 5.

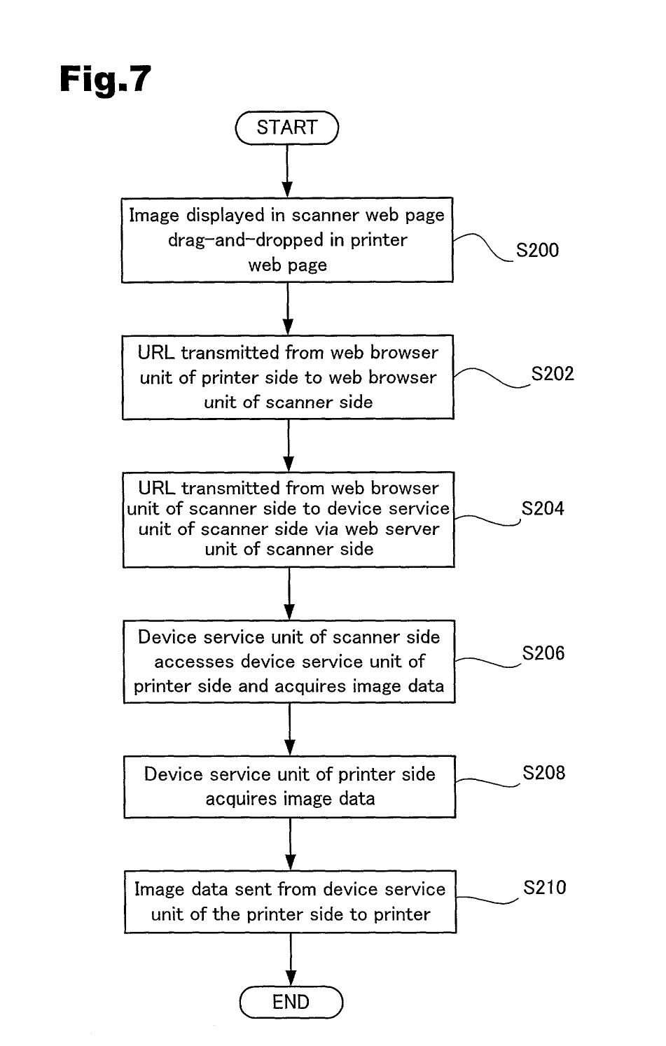

FIG. 7 is a flowchart explaining the process operation for a data transmission system corresponding to the second embodiment of the present invention.

In the computer 300, the user, operating the input unit 308, drags the image 616 displayed in the web page 612 of the scanner 130s by means of the mouse-cursor 618 displayed on screen 600, as shown by the dotted arrow, and drops it inside the command frame 626 displayed in the web page 622 of the printer 230p (step S200). Then, the web browser units 100 and 200 detect that image 616 displayed in the web page 612 of the scanner 130s has been dragged and dropped inside the command frame 626 displayed in the web page 622 of the printer 230p, and, contrary to what happens in the first embodiment, the URL of the device service unit 220 is now delivered to the web browser unit 100 from the web browser unit 200 (step S202).

Next, the web browser unit 100 sends the delivered URL to the web server unit 110 by means of HTTP; the web server unit 110 relays it unchanged to the device service unit 120 (step S204). Then, the device service unit 120 checks the URL and recognises which data to acquire and where to access. Thereupon, the device service unit 120 accesses the target the device service unit 220 via the network 400 using IPP, and sends the image data held by the device service unit 120 itself (step S206). The first the device service unit 220 receives the image data sent (step S208), and delivers that image data to the printer 230p (step S108), where the target image is printed.

That way, in the present embodiment, the user of the computer 300, just by dragging and dropping the image 616 displayed in the web page 612 of the scanner 130s into the printing command frame 626 displayed in the web page 622 of the printer 230p, can transmit via the network 400, the image data for image 616 from the connected the scanner 130s to the printer 230p. Therefore, by means of the present embodiment, it is possible command the transmission of data, by means of a simple operation, without having to run the different application programs for the different devices such as scanners, printers, etc. Also, because the data transmission and information exchange between web browser units and web server units is done using HTTP, and because the image data transmission between device service unit homologues uses IPP, it is possible to carry out data transmission and information exchange making no distinction between local or network connections.

In the embodiment above, the image data transmission between device service unit homologues was performed by means of IPP, but the image data transmission can be done as well using other protocols. To illustrate this point, we shall explain next a modification of the described embodiment.

In this variation, the protocol used is LPR. More specifically, here it is the GUID of the printer 230p, instead of its URL, that is delivered to the web browser unit 100 from the web browser unit 200. The web browser unit 100 delivers the GUID to the device service unit 120 through the web server unit 110. Then the device service unit 120, based on the delivered GUID, accesses the device service unit 220 using LPR and sends the image data held by the device service unit 120 itself to the device service unit 220.

Thus, by carrying out the data transmission between device service units-homologues using LPR, image data can be transmitted making no distinction between local or network connection.

In the above first and second embodiments, we have described a data transmission system by means of a suitable connection embodiment for the data transmission system according to FIG. 2C, but other suitable connection embodiments may also be used, such as the connection embodiments of the related data transmission systems as shown in FIG. 2A, 2B) and FIG. 3A˜3C.

In the above first and second embodiments, when dragging and dropping the image 616 displayed in the web page 612 of the scanner 130s into the printing command frame 626 displayed in the web page 622 of the printer 230p, the hand-over of the URL between the web browser units 100 and 200 begins immediately, but it is also possible to provide for example a “start-printing” button in the web page 622 of the printer 230p; in a way that the hand-over of the URL should be initiated when that start-printing button is clicked after performing the drag-and-drop. Also, instead of having a printing-command frame 626, the hand-over can be initiated by a drag-and-drop in any other location of the web page 622.

In the above first and second embodiments, a scanner was used as the device in the sending end, so the image data held by the device service unit 120 constitute single data; however, if for instance a digital camera is used instead of a scanner, the image data held by the device service unit 120 or the device, 130 now a digital camera, become a plurality of image data. In such cases, it is also possible to display the plurality of images when displaying the web page of the receiving device on the screen of the monitor 309.

Thus, in case of a plurality of images, when drag-and-dropping an image, in order to specify between browsers that drag-and-dropped image, it is possible to deliver the URL of the image data, instead of the URL of the device service unit.

### C. Third Embodiment

In the above first and second embodiments, a URL hand-over between web browser units takes place prompted by the drag-and drop of the images displayed in the web page of one device in the web page of the other device, wherein the URL of the first device is transmitted to the second device, followed by the data transmission.

However, the present invention is not restricted to such embodiments, and can be put in practice as embodiments different from the above. Now we shall explain in detail some of those embodiments with the help of the drawings.

### C-1. Structure of the Third Embodiment

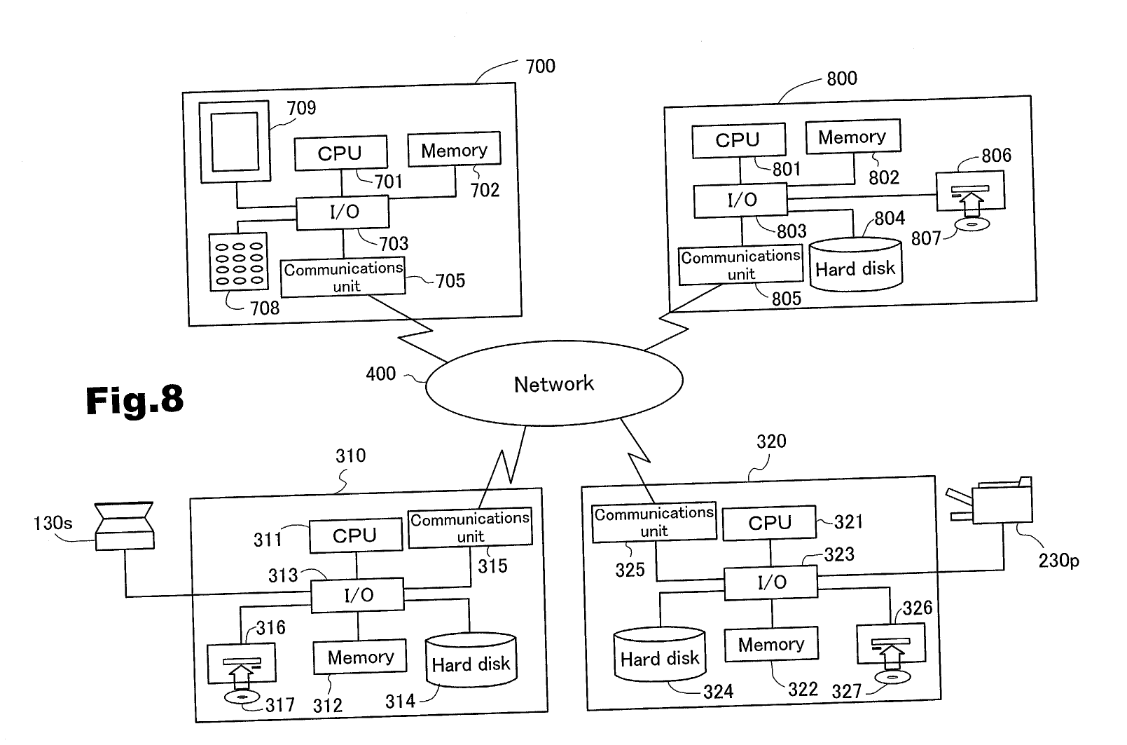

FIG. 8 is a block diagram showing schematically the hardware structure of the data transmission system corresponding to the third embodiment of the present invention. As FIG. 8 shows, this data transmission system incorporates the computer 310 with the scanner 130s and the computer 320 with the printer 230p, already shown In FIG. 4, a cellular phone 700 connectable to the network 400 and a computer for device search 800 connected to the network 400.

The computers 310, 320 and 800 incorporate mainly CPUs 311, 321 and 80 for performing the various control and processing tasks in accordance with the computer programs, memory units 312, 322 and 802 for memorising the computer programs and to temporarily memorise data being processed, I/O elements 313, 323 and 803 for exchanging data etc. among the different peripheral devices, hard disk units 314, 324 and 804 to store the various data, communication elements 315, 325 and 805, including modems, terminal adapters, network cards etc., for communicating with other devices through the network, and CD-ROM drives 316, 326 and 806. Apart from this, as described elsewhere, the computer 310 is connected to an external the scanner 130s, as the sending device, and the computer 320 is connected to an external the printer 230p, as receiving device. Furthermore, input units and monitors have been omitted in the computers 310, 320 and 800.

The cellular phone 700 incorporates mainly a CPU 701 for performing the various control and processing tasks in accordance with the computer programs, a memory units 702 for memorising the computer programs and to temporarily memorise data being processed, an I/O element 703 and 803 for exchanging data etc. among the different peripheral devices, a communication element 705 for wireless communication with other devices through the network, an input key 708 for the input of the user's commands, and a liquid crystal display 709 where web pages can be displayed. Also, it may have other elements for functions proper to a telephone, receiver, etc., which have been omitted. The input key 708 correspond to the input element in claims 1 and 2, a partial function of CPU 701 corresponds to the element for transmission of location data.

In general, these network-connectable cellular phones are wirelessly connected to a nearby base station. From there and by means of a dedicated line, these cellular phones are connected to a general central computer (not shown), and linked to a network 400 like Internet etc. from that central computer. A known example of such Internet access service through cellular telephony is NTT DoCoMo's i-mode.

### C-2: Operation of the Third Embodiment

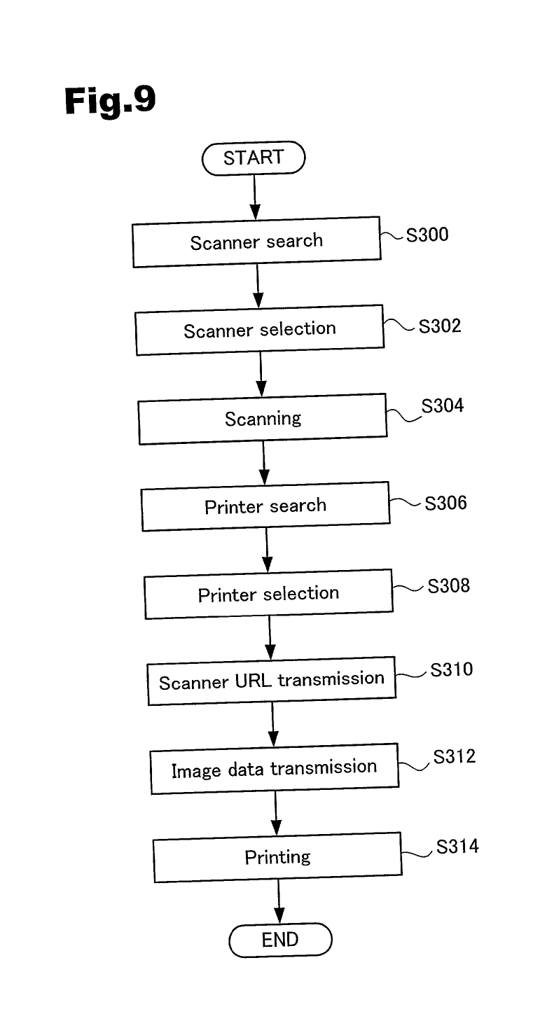

We shall explain the operation of the data transmission system shown in FIG. 8 while referring to FIG. 9. FIG. 9 is a flowchart explaining the process operation for the data transmission system of FIG. 8.

In the present embodiment, based on the commands of the cellular phone, the desired scanner (the scanner 130s) and printer (the printer 230p) are searched, by means of the computer for device search 800, among the devices connected to the network; and the image data read in the scanner 130s is sent via the network 400 to be printed by the printer 230p. All commands are given by the user of the cellular phone 700 using the cellular phone 700 itself.

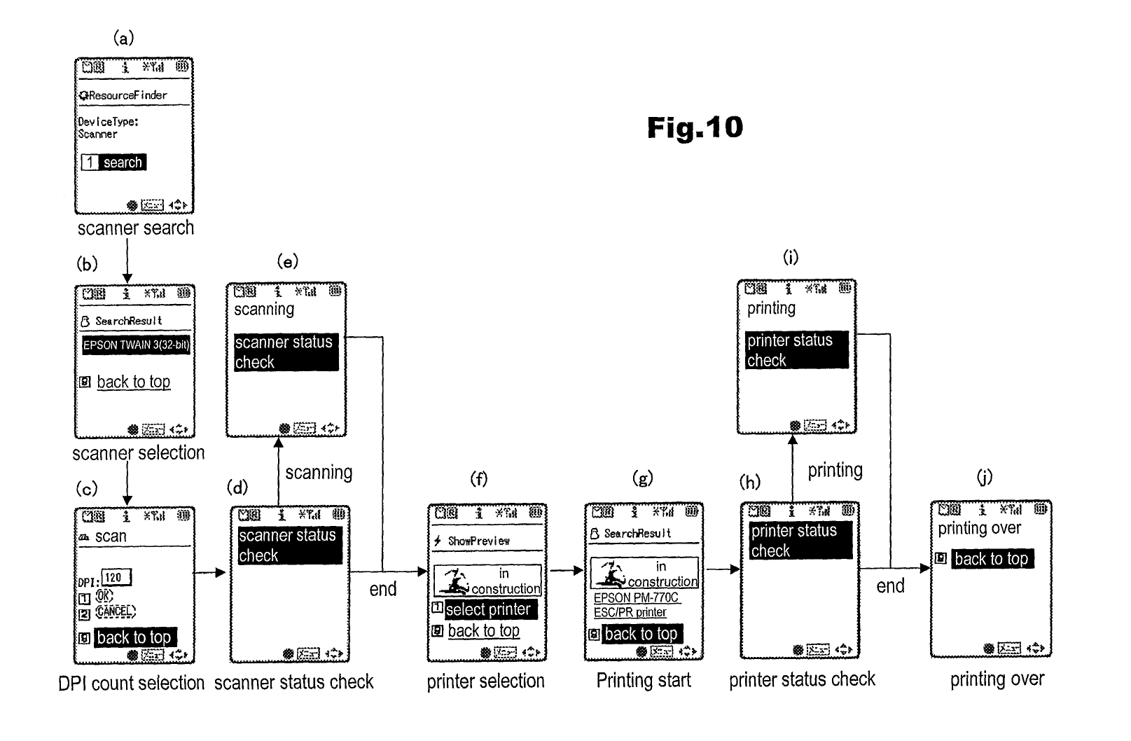

FIG. 10 is a drawing explaining the command procedure for the cellular phone 700 of FIG. 8.

When the user of the cellular phone 700, operating the input key 708, commands the connection to computer for device search 800, the cellular phone 700 accesses computer for device search 800 via the network 400 and requests the data for displaying the web page. Based on this request, computer for device search 800, first sends back to the cellular phone 700 via the network 400 the data for displaying the web page of scanner search. The cellular phone 700, based on the received data, displays the scanner search web page on its liquid crystal display 709, as shown in FIG. 10 (a).

Next, when the user of the cellular phone 700, commands the search of the scanner by operating the input key 708 in the web page shown in FIG. 10 (a), that command is relayed to the computer for device search 800 via the network 400. the computer for device search 800, based on that command, searches the scanner among the devices connected to the network (step S300 in FIG. 9)

The device search proceeds in detail as follows: the computers connected to the printer and the scanner, record beforehand the connected devices as services prior to their running. If the connected device is a scanner, then it is recorded as Object-Class: scanner; if it is a printer, Object-Class: printer. The computer for device search 800, when carrying out the search for the device, first sends to the network 400, as multicast, an embedded packet with the Object-Class (for instance, if a scanner is searched, then Object-Class: scanner) as the search object. Thereupon, the computer with the object class matching the request (e.g., computer 130 if a scanner is searched, etc.), in response to that packet, sends back as unicast a packet containing the location information etc of that computer. The computer for device search 800 receives the packets sent back by all the computers in the network 400 and evaluates the search results.

When a scanner is thus searched, next, the computer for device search 800, based on the search results, creates the data for displaying a web page listing the names etc. of the searched scanners, and sends it back to the cellular phone 700 via the network 400. Based on that data, the cellular phone 700 displays on the screen of its liquid crystal display 709 the web page listing the name etc. of the searched scanner, as shown in FIG. 10 (b).

Then, when the user of the cellular phone 700, operating the input key 708, commands the selection of the desired scanner (i.e., the scanner 130s) in the web page as shown in FIG. 10 (b) (step S302 in FIG. 9), the cellular phone 700, following that command, accesses the computer 310 connected to the scanner 130s via the network 400.

The URL of the respective computers connected to the scanners are embedded beforehand in a part of the listed scanner names to be used by the computer for device search 800 when creating the data for displaying the web page shown in FIG. 10 (b). More specifically, for instance, the link to that computer is established by embedding a URL with link tag <A HREF=“. . . ”>. . . <A>, displayed in HTML. If when web page shown in FIG. 10 (b) is displayed, the user of the cellular phone 700 selects the desired scanner name; the cellular phone 700 reads the embedded URL and, based on it, accesses the computer connected to that scanner.

Thus, when the cellular phone 700 accesses the computer 310 connected to the desired the scanner 130s, it requests the web page data from the computer 310.

The computer 310, responding to the request of the cellular phone 700, sends the data for displaying the web page back to the cellular phone 700 and the cellular phone 700, based on the data, displays on the screen of its liquid crystal display 709 a web page for selecting the DPI (dots per inch) count.

When the user of the cellular phone 700, operating the input key 708 selects the DPI count in order to obtain the corresponding desired resolution in the web page shown in FIG. 10 (c) and enters “OK”, this command is transmitted from the cellular phone 700 to the computer 310 via the network 400, and the computer 310 initiates the scanning with the selected DPI count in the scanner 130s (FIG. 9, step S304). At the same time, the computer 310 causes a web page for scanner status check, as shown in FIG. 10 (d), to be displayed on the screen of the liquid crystal display of the cellular phone 700. Now, when the user of the cellular phone 700 signals “scanner status check”, this command is transmitted to the computer 310, which checks the status of the scanner 130s, reflecting the result of that check on the screen as shown in FIG. 10 (e).

Afterwards, when the scanning operation in the scanner 130s is over, the computer 310 lets a notification web page informing about the completion of the scanning appear on the screen of the liquid crystal display 709 of the cellular phone 700 (not shown). In this web page, a “OK” button is displayed, in which a link (i.e., the URL) to the computer for device search 800 is embedded; when the user of the cellular phone 700 presses the OK button to confirm the completion of the scanning, the cellular phone 700 reads the embedded-in URL and accesses accordingly the computer for device search 800, and requests data for displaying a web page.

The computer 310, upon creating the data for displaying the web page, in a part of the OK button, embeds behind the URL of the computer for device search 800 its own URL or the URL of the image data read by the scanner. Therefore, when the user of the cellular phone 700 presses the OK button, apart from the embedded URL of the computer for device search 800, the cellular phone 700 reads also the URL of the computer 310 or the URL of the image data, and upon accessing the computer for device search 800, delivers to it the read URL of the computer 310 or the URL of the image data.

Next, upon receiving the request from the cellular phone 700, the computer for device search 800, returns the data for displaying the web page for printer search to the cellular phone 700. Based on that data, the cellular phone 700 displays on the screen of the liquid crystal display 709 the web page for printer search, as shown in FIG. 10 (f).

Next, when the user of the cellular phone 700 commands “select printer” in the web page shown in FIG. 10 (f), the computer for device search 800, acting on that command, searches the printers form among the devices connected to the network 400 (step S306 in FIG. 9). Then, based on the result of that search, it creates the data for displaying the web page listing the names of the searched printers and sends it back to the cellular phone 700. Based on that data, the cellular phone 700 displays the web page listing the names of the printers on the screen of its liquid crystal display 709 as shown in FIG. 10 (g).

Next, when the user of the cellular phone 700, operating the input key 708, gives the command to select the desired printer (i.e. the printer 230p) on the web page shown in FIG. 10 (g) (step S308 in FIG. 9), the cellular phone 700, based on that command, the computer 320 connected to the printer 230p accesses via the network 400 and instructs it to initiate the printing.

The URL of the respective computers connected to the printers are embedded beforehand in a part of the listed printer names to be used by the computer for device search 800 when creating the data for displaying the web page shown in FIG. 10 (g). Therefore, once web page shown in FIG. 10 (g) is displayed as described above, when the user of the cellular phone 700 selects the desired printer name, the cellular phone 700 reads the filled-in URL and, based on it, accesses the computer connected to that printer, and instructs the printer to initiate the printing.

When the computer for device search 800 creates the data for displaying the web page, the URL of the computer connected to the scanner first selected by the user (i.e. the scanner 130s), or the URL of the image data read by that scanner, is embedded behind the URL of the respective computers connected to the printer names listed in the web page.

For instance, if the scanner selected by the user is scanner S1 and the printers after printer search are printer P1, printer P2 and printer P3, along with the listed names of each printer P1, P2 and P3, the URL for printer P1 and the URL for scanner S1 are embedded in a part of the printer name of printer P1 in the web page, similarly the URL for printer P2 and the URL for scanner S1 are embedded in a part of the printer name of printer P2, and the URL for printer P3 and the URL for scanner S1 are embedded in a part of the printer name of printer P3.

Therefore, with the web page shown in FIG. 10 (g) displayed, when the user of the cellular phone 700 selects the name of the desired printer (i.e. the printer 230p) as explained above, the cellular phone 700 reads the embedded URL of the computer 320 connected to the printer 230p and reads also thereafter, the URL of the computer 310 connected to the scanner 130s previously selected by the user, or the URL of the image data read by that the scanner 130s. Then, when the cellular phone 700 signals the initiation of the printing by accessing the computer 320 connected to the printer 230p, it delivers to the computer 320 the URL of the computer 310 or the URL of the image data (i.e., the URL for the scanner 130s) just read (step S310 in FIG. 9).

That way, the computer 320 accesses the computer 310 based on the received URL of the computer 310 or the received URL of he image data. The image data read by the scanner 130s is usually stored in the computer 310 connected to it, so the URL of the computer 310 is contained in the URL of the image data. Therefore, it is possible to access the computer 310 based on the URL of the image data.

Next, the computer 320 requests from the accessed the computer 310 the transmission of the image data, whereupon the computer 310 transmits the image data read by the scanner 130s to the computer 320 via the network 400 (FIG. 9 step S312).

Computer 320 hands the received image data over to the printer 230p, and in response to the start-printing command from the cellular phone 700, the printing of the image is initiated in the printer 230p (FIG. 9 step S314). At the same time, the computer 320 lets a web page for printer status check, as shown in FIG. 10 (h) be displayed on the screen of the liquid crystal display 709 of the cellular phone 700. Now, when the user of the cellular phone 700 commands “printer status check”, that command is transmitted to the computer 320, which checks the status of the printer 230p, reflecting the result of that check on the screen as shown in FIG. 10(i).

Afterwards, once the printing operation in the printer 230p is over, the computer 320 lets a notification web page informing about the completion of the printing appear on the screen of the liquid crystal display 709 of the cellular phone 700, as shown in FIG. 10 (i).

Thus, in the present embodiment, the user issues commands using the cellular phone 700, and by selecting the desired the scanner 130s or the printer 230p, the cellular phone 700 transmits to the computer 320 connected to the printer 230p the URL of the computer 310 connected to the scanner 130s or the URL of the image data read by the scanner 130s; based on these URL's, the computer 320 connected to the printer 230p accesses the computer 310 connected to the scanner 130s, and receives the transmission of the image data from the computer 310. Therefore, according to the present embodiment, the user of the cellular phone 700, just selecting the desired the scanner 130s and the printer 230p, can transmit image data from the computer connected to the scanner 130s to the computer connected to the printer 230p through the network 400. Therefore, it is possible to implement commands for data transmissions by means of a simple operation, without running the different application programs for each device, scanner and printer.

In the above embodiment, when the user of the cellular phone 700 checks the end of the printing operation, the search process immediately moves onto the next printer, but it is possible to include a preview operation for previewing the scanned image data before moving onto the search of the next printer.

In this case, when the scanning operation of the scanner 130s is over, the computer 310 generates the preview data from the image data read by the scanner. As explained above, the computer 310 lets a notification web page inform about the completion of the scanning as it appears on the screen of the liquid crystal display 709 of the cellular phone 700 (not shown). In this web page there is a “preview” button with an embedded link (i.e. the URL) to the generated image preview data. Therefore, when the user presses the “preview” button, the cellular phone 700 reads the embedded URL and accesses accordingly the computer 310, requesting the transmission of the image preview data. Acting on that request, the computer 310 transmits the image preview data to the cellular phone 700 via the network 400. The cellular phone 700, based on the transmitted image data, displays the preview of the scanned image on the screen of the liquid crystal display 709.

By means of this arrangement, the user of the cellular phone 700 can check immediately the scanned image, so it can select only the necessary images to be printed by the printer 230p.

### D. Fourth Embodiment

In the third embodiment described above, the user of the cellular phone 700, upon selecting the scanner 130s, caused the cellular phone 700 to access the computer 310 connected to the scanner 130 in order to carry out the scanning, but the present invention is not restricted to such an embodiment. It is also possible to arrange that, when the user selects the desired scanner the cellular phone 700 does not access the computer connected to the scanner, but on the other hand, once the user of the cellular phone 700 selects the desired printer, the computer connected to the printer accesses the computer connected to the scanner, making the scanner carry out the scanning. We shall describe below such an embodiment.

The structure of the present embodiment is identical to that shown in FIG. 8, so we shall omit its description here.

### D-1. Operation of the Fourth Embodiment

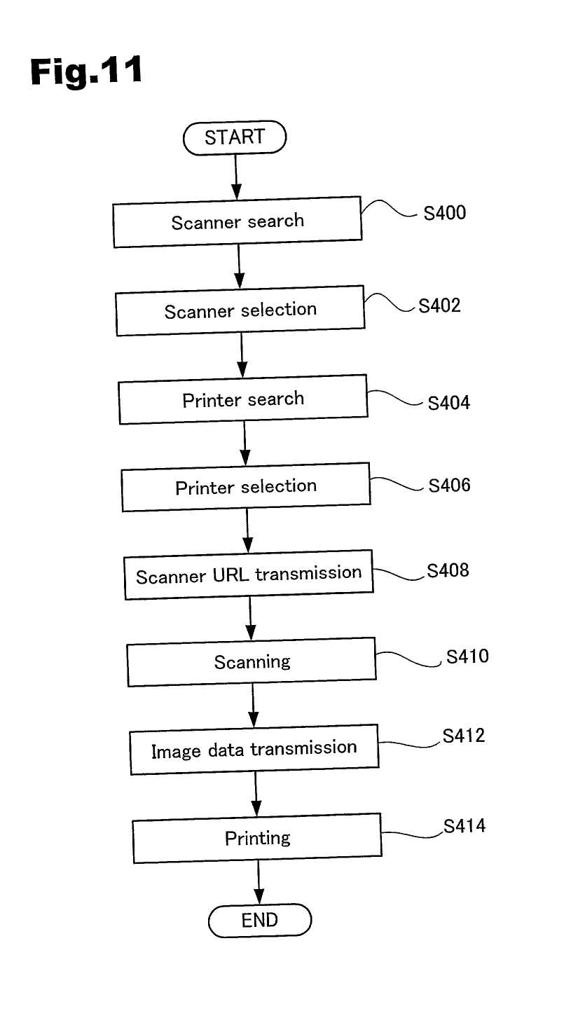

FIG. 11 is a flowchart explaining the process operation for a data transmission system corresponding to the fourth embodiment of the present invention.

In the present embodiment, as shown in FIG. 11, the operational sequence from the start of the process up to scanner selection (step S402) is identical to that in the third embodiment described already in FIG. 9, so these steps will not be explained here.

When the user of the cellular phone 700 selects the desired scanner (i.e. the scanner 130s) in a web page as the one shown in FIG. 10 (b) (step S402), unlike in the third embodiment, the cellular phone 700 accesses a second time the computer for device search 800 via the network 400 and delivers the URL of the computer 310 connected to the selected the scanner 130s to the computer for device search 800, delivering also the request for the data necessary to display the web page.

In the present embodiment, when the computer for device search 800 generates the data for displaying the web page shown in FIG. 10 (b) , here, unlike in the third embodiment, in a part of each of the listed scanner names, the corresponding common URL of the computer for device search 800 is embedded, and behind it, the URL of the computer connected to the scanner. Therefore, with the web page shown in FIG. 10 (b) displayed, when the user of the cellular phone 700 selects the desired scanner name, the cellular phone 700 reads the URL of the computer for device search 800 embedded therein, and based on that URL, accesses the computer for device search 800, reads as well the embedded URL of the computer connected to the selected scanner, and delivers it to the computer for device search 800.

Next, when the computer for device search 800 receives the request from the cellular phone 700, it sends the data for displaying the web page for printer search back to the cellular phone 700. The cellular phone 700, based on this data, displays on the screen of its liquid crystal display 709 the web page for printer search, as shown in FIG. 10 (f).

Next, when the user of the cellular phone 700 commands the printer search in the web page shown in FIG. 10 (f), the computer for device search 800 searches among the devices connected to the network 400 (FIG. 11 step S404), and based on the search result, it creates the data for displaying the web listing the names of the searched printers and sends it back to the cellular phone 700. Based on that data, the cellular phone 700 displays on the screen of its liquid crystal display 709 the web page listing the names of the printers, as shown in FIG. 10 (g).

Next, when the user of the cellular phone 700 selects the desired printer (i.e. the printer 230p) in the web page shown in FIG. 10 (g) (FIG. 11 step S406), just like in the third embodiment, the cellular phone 700 accesses the computer 320 connected to the printer 230p through the network 400 and signals the initiation of the printing in the printer 230p, and at the same time delivers to the computer 320 the URL of the computer 310 connected to the scanner 130s selected previously or the URL of the image data read by that scanner (step S408).

Thus, the computer 320, based on the received URL of the computer 310 or the received URL of the image data, accesses the computer 310 and requests to the latter the initiation of the image scanning. As a result, the computer 310 lets the scanner 130s initiate the scanning (step S410). After that, once the scanning operation is over, the computer 310 informs the computer 320, the computer 320 then requests the transmission of the image data to the computer 310. In response, the computer 310 sends the image data read by the scanner 130s to the computer 320 via the network 400 (step S412).

The computer 320 receives the transmitted image data and sends it to the printer 230p in order to start the printing of the image (step S414). After that, when the printing operation in the printer 230p is over, the computer 320 lets a web page notifying the end of the printing be displayed on the screen of the liquid crystal display 709 of the cellular phone 700, as shown in FIG. 10 (j).

Thus, in the present embodiment, the user gives commands through the cellular phone 700, selecting the desired the scanner 130s and the printer 230p; the cellular phone 700 transmits to the computer connected to the printer 230p the URL of the computer 310 connected to the scanner 130s or the URL of the image data read by the scanner 130s; based on these URL's, the computer 320 connected to the printer 230p accesses the computer 310 connected to the scanner 130s, and receives the transmission of the image data from that the computer 310. Therefore, according to the present embodiment, the user of the cellular phone 700, just selecting the desired the scanner 130s and the printer 230p, can transmit image data from the computer connected to the scanner 130s to the computer connected to the printer 230p through the network 400. Thus, it is possible to implement commands for data transmissions by means of a simple operation, without running the different application programs for each device, scanner and printer.

In the present embodiment, as compared with the third embodiment, the cellular phone 700 does not access the computer 310 connected to the scanner 130s; and since it does not display the web page from that the computer 310, the time required for the whole process or part of it is shortened.

### E. Fifth Embodiment

In the above fourth embodiment, the cellular phone 700 transmits to the computer connected to the printer 230p the URL of the computer 310 connected to the scanner 130s or the URL of the image data read by the scanner 130s; based on these URL's, the computer 320 connected to the printer 230p accesses the computer 310 connected to the scanner 130s, and receives the transmission of the image data from that the computer 310; but the present invention is not restricted to such an embodiment, an alternative is also possible where, in a reverse of the above, the cellular phone 700 sends the URL of the computer 320 connected to the printer 230p to the computer 310 connected to the scanner 130s, and based on that URL, the computer 310 connected to the scanner 130s accesses the computer connected to the printer 230p and transmits to this the computer 320 the image data. We shall discuss below such an embodiment.

The structure of the present embodiment is identical to the one shown in FIG. 8, so it will not be explained again.

### E-1. Operation of the Fifth Embodiment

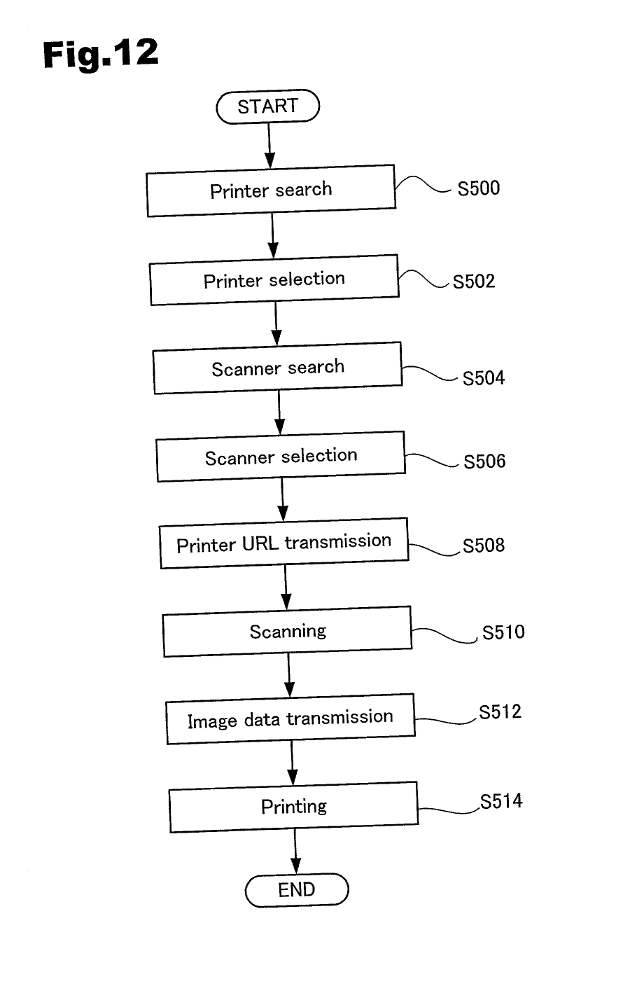

FIG. 12 is a flowchart explaining the process operation for a data transmission system corresponding to the fifth embodiment of the present invention.

First, when the user of the cellular phone 700, operating its input key 708, commands the connection with the computer for device search 800, the cellular phone 700 accesses the computer for device search 800 through the network 400 and requests the data for displaying a web page. Based on this request, the computer for device search 800, unlike in the third embodiment, delivers first the data for displaying the web page for printer search to the cellular phone 700. Then the cellular phone 700, based on that data, displays on the screen of its liquid crystal display 709 the web page for printer search as shown in FIG. 10 (f).

Next, when the user of the cellular phone 700 commands “search printer” in the web page shown in FIG. 10 (f), the computer for device search 800, searches the printer among the devices connected to the network 400 (FIG. 12 step S500); based on the result of that search, it creates the data for displaying the web page listing the names of the searched printers and sends it back to the cellular phone 700. Based on that data, the cellular phone 700 displays the web page listing the names of the printers on the screen of its liquid crystal display 709 as shown in FIG. 10 (g).

Next, when the user of the cellular phone 700 gives the command to select the desired printer (i.e. the printer 230p) in the web page shown in FIG. 10 (g) (step S502 in FIG. 12), the cellular phone 700 accesses a second time the computer for device search 800 through the network 400 to request the data for displaying a web page, and at the same time sends the URL of the computer 320 connected to the selected the printer 230p to the computer for device search 800.

In the present embodiment, when the computer for device search 800 generates the data for displaying the web page shown in FIG. 10 (b) , here, unlike in the third embodiment, the corresponding common URL of the computer for device search 800 is embedded in a part of each of the listed printer names, and behind it, the URL of the computer connected to the scanner. Therefore, with the web page shown in FIG. 10 (g) displayed, when the user of the cellular phone 700 selects the desired printer name, the cellular phone 700 reads the URL of the computer for device search 800 embedded therein, and based on that URL, accesses the computer for device search 800 and reads as well the embedded URL of the computer connected to the selected printer, and delivers it to the computer for device search 800.

Next, when the computer for device search 800 receives the request from the cellular phone 700, it sends the data for displaying the web page for scanner search back to the cellular phone 700. The cellular phone 700, based on this data, displays on the screen of its liquid crystal display 709 the web page for scanner search, as the one shown in FIG. 10 (a).

Next, when the user of the cellular phone 700 commands the scanner search in the web page shown in FIG. 10 (a), the computer for device search 800 searches among the devices connected to the network 400 (FIG. 12 step S504); and based on the search result, it creates the data for displaying the web listing the names of the searched scanners and sends it back to the cellular phone 700. Based on that data, the cellular phone 700 displays on the screen of its liquid crystal display 709 the web page listing the names of the scanners, as shown in FIG. 10 (b).

Next, when the user of the cellular phone 700 selects the desired scanner (i.e. the scanner 130s) in the web page shown in FIG. 10 (b) (FIG. 12 step S506), the cellular phone 700 accesses the computer 310 connected to the scanner 130s through the network 400 and signals the initiation of the scanning.

In the present embodiment, when the computer for device search 800 generates the data for displaying the web page shown in FIG. 10 (b), here, unlike in the third embodiment, the URL of the respective computer connected to that scanner is embedded in a part of each of the listed scanner names, and the URL of the computer (i.e. the computer 310) connected to the printer (i.e. the printer 230p) selected previously by the user of the cellular phone 700 is also embedded.

Therefore, with the web page shown in FIG. 10 (b) displayed, when the user of the cellular phone 700 selects the name of the desired scanner (i.e. the scanner 130s), the cellular phone 700 reads the embedded URL of the computer 310 connected to the scanner 130s, and based on the that URL, accesses that the computer 310, and signals the initiation of the scanning in the scanner 130s; the cellular phone 700 reads also the embedded URL of the computer 320 connected to the selected the printer 230p and delivers it to the computer 310 (FIG. 12 step S508)

The computer 310, acting on the command from the cellular phone 700, initiates first the scanning of the image in the scanner 130s (step S510). After that, once the scanning operation is over, the computer 310 accesses next the computer 320 using the URL of the computer 320 received from the cellular phone 700, and transmits directly the image data read by the scanner 130s to the computer 320 via the network 400 (step S512), and requests computer 320 to initiate the printing of the image in the printer 230p (FIG. 12 step S514). The image data transmitted to the computer 320 when the computer 310 accesses the latter may be transmitted using IPP, as in the second embodiment described before.

Thus, in the present embodiment, unlike in the third embodiment, the user of the cellular phone 700 inputs commands and selects the desired the printer 230p and the scanner 130s; the cellular phone 700 transmits the URL of the computer 320 connected to the printer 230p to the computer 310 connected to the scanner 130; based on that URL, the computer 310 connected to the scanner 130s accesses the computer 320 connected to the printer 230p and transmits the image data to that the computer 320. Therefore, according to the present embodiment, the user of the cellular phone 700, just selecting the desired the scanner 130s and the printer 230p, can transmit image data from the computer connected to the scanner 130s to the computer connected to the printer 230p through the network 400. Thus, it is possible to implement commands for data transmission by means of a simple operation, without running the different application programs for each device, scanner and printer.

In the above third to fifth embodiments, there was a direct transmission of image data from the computer 310 connected to the scanner 130s to the computer 320 connected to the printer 230p via the network 400, but the image data can be also transmitted via other computers. Such a variation is described below.

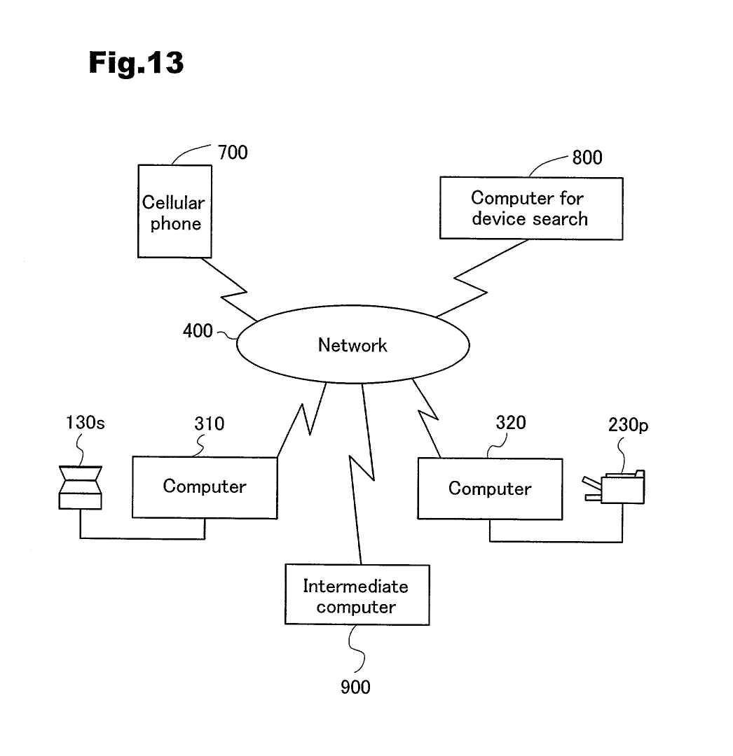

FIG. 13 is a block diagram depicting a variation of the data transmission system of the present invention. As shown in FIG. 13, in this variation, there is a intermediate computer connected to the network 400 in the structure shown in FIG. 8.

In this variation, therefore, when the image data is to be transmitted from the computer 310 connected to the scanner 130s to the computer 320 connected to the printer 230p through the network 400, it is first transmitted from the computer 310 to the intermediate computer 900 connected to the network 400, and then transmitted form the intermediate computer 900 to the computer 320 via the network 400.

In this case, the intermediate computer 900 may send the image data received from the computer 310 unchanged to the computer 320, or it may carry out any desired image treatment on the image data. This kind of intermediate computer need not necessarily be just one, a plurality of them may be also disposed in between.

In the above third to fifth embodiments, a cellular phone 700 wirelessly connectable to the network 400 was used for the transmission of the URL's in response to the command input of the user. However the present invention is not limited to such embodiments, it makes no difference what kind of device it may be as long as it can be connected to the network 400. That is, apart from cellular phones, other portable information terminals such as PHS, PDA units of electronic notebooks may also be used.

In the above third to fifth embodiments, the computer 310 connected to the scanner 130s, the computer 320 connected to the printer 230p and the computer for device search 800 are all three physically independent machines, but it is also possible to integrate the functions of any of these three computers into a single machine or two machines.

In all the embodiments described above, the data transmission examples explained have involved the transmission of stationary image data, but the present invention can be also suited to the transmission of data other than stationary image data, such as animation data, sound data, text data, etc.

In all the embodiments described above, the devices in the examples above have been scanners and printers, but, for the transmission of stationary image date, other devices such as digital cameras or faxes can be used as well. For animated images, all kind of equipment supporting animated images, such as television sets, video recorders etc may be used. For sound data, all kind of audio equipment may be used.

Also, in all the embodiments described above, data was ultimately transmitted from one device to another device, but he present invention is not restricted to such embodiments, it can also be used without devices. That its, even if there are no devices present, the present invention can still be used for the transmission of data from one computer to another computer.

The scope and spirit of the present invention are limited only by the terms of the appended claims.

What is claimed is:

1. A data transmission system for transmission of specific data obtained in a first device to a second device via a network, comprising:
an input element for inputting instructions; and
a location information transmission element that transmits at least one of a location information of the first device and a location information of the specific data to the second device via the network based on the instructions,
wherein the second device accesses the first device based on the location information and receives the transmission of the specific data from the first device.

2. A data transmission system according to claim 1, wherein the input element and the location information transmission element are included in a device other than the first and the second devices.

3. A data transmission system according to claims 1, wherein the specific data is transmitted from the first device to the second device via a device connected to the network other than the first and the second devices.

4. A data transmission system according to claims 1, further comprising:
a search element that can search device groups belonging to at least one of the first and the second devices among devices connected to the network based on the instructions.

5. A data transmission system for transmission of specific data obtained in a first device to a second device via a network, comprising:
an input element for inputting instructions; and
a location information transmission element transmits a location information of the second device to the first device based on the instructions,
wherein the first device accesses the second device based on the location information and transmits the specific data to the second device.

6. A data transmission system according to claim 5, wherein the input element and the location information transmission element are included in a device other than the first and the second devices.

7. A data transmission system according to claims 5, wherein the specific data is transmitted from the first device to the second device via a device connected to the network other than the first and the second devices.

8. A data transmission system according to claims 5, further comprising:
a search element that can search device groups belonging to at least one of the first and the second devices among devices connected to the network based on the instructions.

9. A data transmission method for transmission of specific data obtained in a first device to a second device via a network, comprising the steps of:
(a) transmitting at least one of a location information of the first device and a location information of the specific data to the second device via the network based on an inputted instruction; and
(b) causing the second device to access the first device based on the location information and receive the transmission of the specific data from the first device.

10. A data transmission method for transmission of specific data obtained in a first device to a second device via a network, comprising the steps of:
(a) transmitting the location information of the second device to the first device via the network based on an inputted instruction; and
(b) causing the first device to access the second device based on the location information and transmit the specific data to the second device.

11. A data transmission system for transmission of specific data obtained in a first device to a second device, comprising:
a first device service unit that generates data in order to display a web page used for the first device, and which can exchange the specific data with the first device;
a second device service unit that generates data in order to display a web page used for the second device, and which can exchange the specific data with the second device;
a first web server unit that sends the data generated by the first device service unit according to a request;
a second web server unit that sends the data generated by the second device service unit according to a request;
a first web browser unit that sends the request to the first server unit, receives the data sent by the first server unit, and which, based on the data, displays the web page used for the first device including data symbols for displaying the specific data on a screen;
a second web browser unit that sends the request to the second server unit, receives the data sent by the second server unit, and which, based on the data, displays the web page used for the second device on same the screen,
wherein, when the data symbols on the screen included in the web page used for the first device are drag-and-dropped in a predetermined area of the web page used for the second device, the first web browser unit hands over at least one of a location information of the first device service unit and a location information of the specific data to the second web browser unit, the second web browser unit forwards the handed over location information to the second device service via the second web server unit, and the second device service unit accesses the first device service unit based on the forwarded location information, acquires from the first device service unit the specific data obtained from the first device, and sends the specific data over to the second device.

12. A data transmission system according to claim 11, further comprising:
a third web server unit provided between the first device service unit and the second device service unit,
wherein the second device service unit accesses the first device service unit via the third web server unit based on the delivered location information, and acquires the specific data from the first device service unit using HTTP (Hypertext Transfer Protocol) via the third web server unit.

13. A data transmission system according to claim 11, further comprising:
a FTP server unit provided between the first device service unit and the second device service unit,
wherein the second device service unit accesses the first device service unit via the FTP server unit based on the delivered location information, and acquires the specific data from the first device service unit using FTP (File Transfer Protocol) via the FTP web server unit.

14. A data transmission system according to claim 11, wherein the second device service unit acquires the specific data from the first device service unit using IPP (Internet Printing Protocol).

15. A data transmission system for transmission of specific data obtained in a first device to a second device, comprising:
a first device service unit that generates data in order to display a web page used for the first device, and which can exchange the specific data with the first device,
a second device service unit that generates data in order to display a web page used for the second device, and which can exchange the specific data with the second device,
a first web server unit that sends the data generated by the first device service unit according to a request,
a second web server unit that sends the data generated by the second device service unit according to a request,
a first web browser unit that sends the request to the first server unit, receives the data sent by the first server unit, and which, based on the data, displays the web page used for the first device including data symbols for displaying the specific data on a screen,
a second web browser unit that sends the request to the second server unit, receives the data sent by the second server unit, and which, based on the data, displays the web page used for the second device on same the screen;
wherein, when the data symbols on the screen included in the web page used for the first device are drag-and-dropped in a predetermined area of the web page used for the second device, the second web browser unit hands over a location information of the second device service unit to the first web browser unit, the first web browser unit forwards the handed over location information to the first device service unit via the first web server unit, the first device service unit accesses the second device service unit based on the forwarded location information and sends the specific data obtained from the first device over to the second device service unit, and the second device service unit receives the specific data and delivers the specific data to the second device.

16. A data transmission system according to claim 15, wherein the first device service unit transmits the specific data to the second device service unit using IPP (Internet Printing Protocol).

17. A data transmission system according to claim 15, wherein the first device service unit transmits the specific data to the second device service unit using LPR.

18. A data transmission method for transmission of specific data obtained in a first device to a second device, comprising the steps of:
(a) providing a first device service unit that generates data in order to display a web page used for the first device, and which can exchange the specific data with the first device, a second device service unit that generates data in order to display a web page used for the second device, and which can exchange the specific data with the second device, a first web server unit that sends the data generated by the first device service unit according to a request, a second web server unit that sends the data generated by the second device service unit according to a request, a first web browser unit that sends the request to the first server unit, receives the data sent by the first server unit, and which, based on the data, displays the web page used for the first device including data symbols for displaying the specific data on a screen, and a second web browser unit that sends the request to the second server unit, receives the data sent by the second server unit, and which, based on the data, displays the web page used for the second device on same the screen;
(b) drag-and-dropping the data symbols on the screen included in the web page used for the first device in a predetermined area of the web page used for the second device;
(c) causing the first web browser unit to hand over at least one of a location information of the first device service unit and a location information of the specific data to the second web browser unit;
(d) causing the second web browser unit to forward the handed over location information to the second device service unit via the second web server unit;
(e) causing the second device service unit to access the first device service based on the forwarded location information and acquire from the first device service unit the specific data obtained from the first device; and
(f) causing to the second device service unit to hand over the acquired specific data to the second device.

19. A data transmission method for transmission of specific data obtained in a first device to a second device, comprising the steps of:
(a) providing a first device service unit that generates data in order to display a web page used for the first device, and which can exchange the specific data with the first device, a second device service unit that generates data in order to display a web page used for the second device, and which can exchange the specific data with the second device, a first web server unit that sends the data generated by the first device service unit according to a request, a second web server unit that sends the data generated by the second device service unit according to a request, a first web browser unit that sends the request to the first server unit, receives the data sent by the first server unit, and which, based on the data, displays the web page used for the first device including data symbols for displaying the specific data on a screen, and a second web browser unit that sends the request to the second server unit, receives the data sent by the second server unit, and which, based on the data, displays the web page used for the second device on same the screen;
(b) drag-and-dropping the data symbols on the screen included in the web page used for the first device in a predetermined area of the web page used for the second device;
(c) causing the second web browser unit to hand over a location information of the second device service unit to the first web browser unit;
(d) causing the first web browser unit to forward the handed over location information to the first device service unit via the first web server unit;
(e) causing the first device service unit to access the second device service unit based on the forwarded location information and send the specific data obtained from the first device over to the second device service unit;
(f) causing the second device service unit to receive the specific data; and
(g) causing the second device service unit to deliver the received specific data to the second device.
